(19) United States
(12) Patent Application Publication
(10) Pub. No.: US 2026/0001592 A1
(43) Pub. Date: Jan. 1, 2026

(54) VEHICLE FENDER ASSEMBLY

(71) Applicant: NISSAN NORTH AMERICA, INC., Franklin, TN (US)

(72) Inventor: Barry KENNEDY, Ypsilanti, MI (US)

(21) Appl. No.: 18/759,404

(22) Filed: Jun. 28, 2024

(51) Int. Cl. B62D 25/18; B60R 13/04; B60R 13/08; B62D 25/16; B62D 65/02

(52) U.S. Cl. CPC B62D 25/18; B60R 13/04; B60R 13/0861; B62D 25/163; B62D 65/02

(57) ABSTRACT

A vehicle fender assembly includes a fender, a fender baffle and a trim molding. The fender is part of a vehicle body defining a tire installation area. The fender baffle is a sound reducer installed to the fender. The fender baffle has an alignment ramp defining a bottom outer edge of the fender baffle that faces a vehicle direction when the fender baffle is installed to the fender. The trim molding is installed to the fender and the fender baffle along the alignment ramp. The alignment ramp enables the trim molding to rotate towards the fender during installation to enclose a gap between the fender and the fender baffle.

### BACKGROUND

### Technical Field

The present disclosure generally relates to a vehicle fender assembly. More specifically, the present disclosure relates to a vehicle fender assembly provided for proper door installation.

### Background Information

vehicle fender is preferably made of stamped metal that serves as a barrier between the front and rear wheels. The vehicle fender forms part of the vehicle body extending from the vehicle's bumper and the vehicle door. The fender also serves to contain dirt and debris during vehicle driving and to keep debris from entering the vehicle interior or the engine compartment. The fender baffle is a sound reducer installed to the fender. That is, the fender baffle serves to reduce noise from the engine and to keep dirt and debris from entering the vehicle body. The fender baffle is a plate that is provided to the fender to help reverse exhaustion pipe flow. It has been realized that installation of the fender baffle to the fender can cause misalignment of the fender baffle.

### SUMMARY

In view of the state of the known technology, one aspect of the present disclosure is to provide a vehicle fender assembly comprising a fender, a fender baffle and a trim molding. The fender is part of a vehicle body defining a tire installation area. The fender baffle is a sound reducer installed to the fender. The fender baffle has an alignment ramp defining a bottom outer edge of the fender baffle that faces a vehicle direction when the fender baffle is installed to the fender. The trim molding is installed to the fender and the fender baffle along the alignment ramp. The alignment ramp enables the trim molding to rotate towards the fender during installation to enclose a gap between the fender and the fender baffle.

In view of the state of the known technology, one aspect of the present disclosure is to provide a method for assembling a vehicle fender assembly. The method comprises installing a fender baffle that is a sound reducer to a fender that is part of a vehicle body defining a tire installation area. The fender baffle has an alignment ramp defining a bottom outer edge of the fender baffle. The method further comprises installing a trim molding to the fender and the fender baffle by sliding the trim molding along the alignment ramp to rotate the trim molding towards the fender during installation to enclose a gap between the fender and the fender baffle.

### BRIEF DESCRIPTION OF THE DRAWINGS

Referring now to the attached drawings which form a part of this original disclosure:

FIG. 1 is side elevational view of a vehicle fender assembly in accordance with an illustrated embodiment;

FIG. 2 is an enlarged perspective view of a portion of the vehicle fender assembly of FIG. 1;

FIG. 3 is an exploded perspective view of the vehicle fender assembly of FIGS. 1 and 2;

FIG. 4 is an enlarged side view of a portion of the vehicle fender assembly with a trim molding of the vehicle fender assembly exploded from the other components;

FIG. 5 is an enlarged bottom view of a portion of the vehicle fender assembly showing installation of the trim molding;

FIG. 6 is an enlarged cross-sectional view of a portion of the vehicle fender assembly showing the trim molding being installed; and

FIG. 7 is an enlarged cross-sectional view of the portion of the vehicle assembly of FIG. 6 showing the trim molding fully installed.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

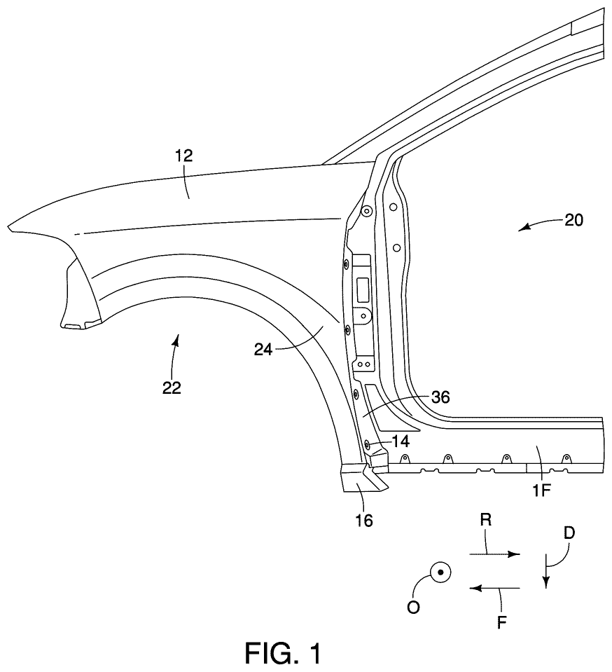

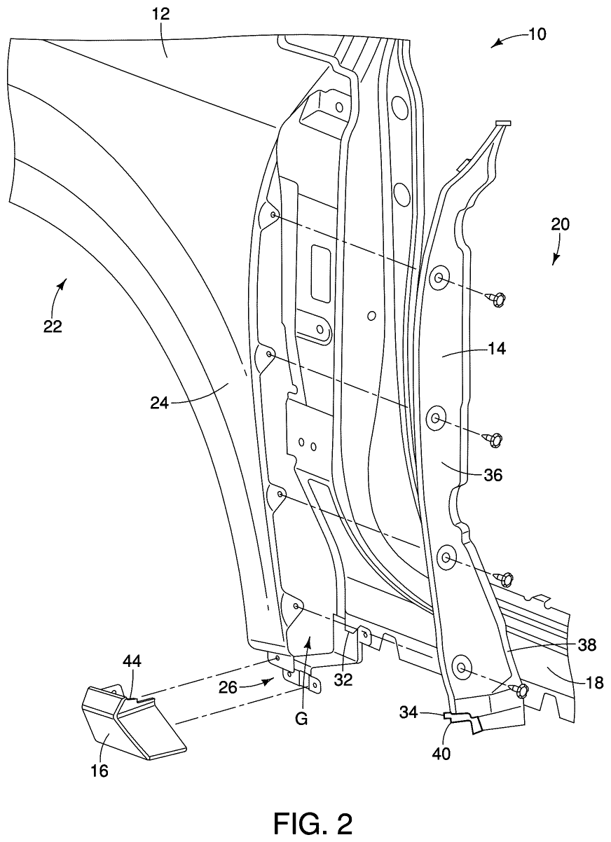

A vehicle fender assembly 10 comprising a fender 12, a fender baffle 14 and a trim molding 16. The vehicle fender assembly 10 further comprises a sill 18. The vehicle fender assembly 10 can be considered part of a vehicle body for a vehicle that is equipped with the fender assembly 10. The vehicle fender assembly 10 is provided to support a vehicle door (not shown). The fender 12 partially defines a front body structure of the vehicle body. The sill 18 includes a rocker trim panel and at least partially defines an underbody of the vehicle. As seen in FIGS. 1 and 2, the sill 18 and the fender 12 together partially define a vehicle door opening 20 for installing a vehicle door thereto.

The sill 18 is a rigid panel preferably made of a durable material, such as stamped steel. The sill 18 extends longitudinally along the front and rear doors and is disposed below the front and rear doors. The fender 12 is installed to the sill 18 with the fender baffle 14 disposed between the fender 12 and the sill 18. It will be apparent to those skilled in the vehicle field from this disclosure that while the vehicle fender assembly 10 illustrated partially defines a front driver's side door, the vehicle fender assembly 10 can be provided for the front passenger's side door as needed and/or necessary.

The fender 12 is part of the vehicle body and also at least partially defines a tire installation area 22 for installing a vehicle tire or a vehicle wheel thereto. As best seen in FIGS. 2 to 5, the fender 12 includes a main body 24 and a lower attachment structure 26 extending below the main body 24. The main body 24 is provided as a plate preferably made of stamped metal. The lower attachment structure 26 is received by the trim molding 16 to fixedly connect the fender 12 to the fender baffle 14. That is, the trim molding 16 is fixed to the fender 12 at the lower attachment structure 26.

The vehicle fender 12 is preferably made of stamped metal that serves as a barrier between the front and rear wheels. The vehicle fender 12 forms part of the vehicle body extending from the vehicle's bumper (not shown) and the vehicle door. The fender 12 also serves to contain dirt and debris during vehicle driving and to keep debris from entering the vehicle interior or the engine compartment.

The fender baffle 14 is a sound reducer installed to the fender 12. That is, the fender baffle 14 serves to reduce noise from the engine and to keep dirt and debris from entering the vehicle body. The fender baffle 14 is a plate that is provided to the fender 12 to help reverse exhaustion pipe flow. It has been realized that installation of the fender baffle 14 to the fender 12 can cause misalignment of the fender baffle 14. As a result, the trim molding 16 can be installed too far outward with respect to the fender 12 and the fender baffle 14. In this instance, the misalignment between the fender 12, the fender baffle 14 and the trim molding 16 can cause mis-installation of the vehicle door leading to interference of the door swinging. In the illustrated embodiment, the terms “outward” or “outer” will refer to a vehicle outward direction O or towards the vehicle outward direction O that faces a vehicle exterior as opposed towards an interior of the vehicle that is equipped with the vehicle fender assembly 10.

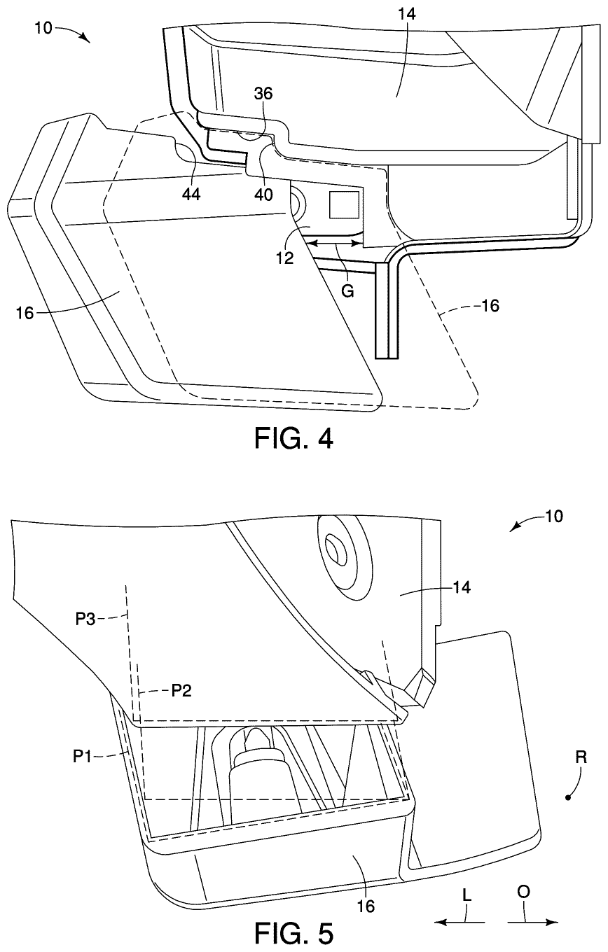

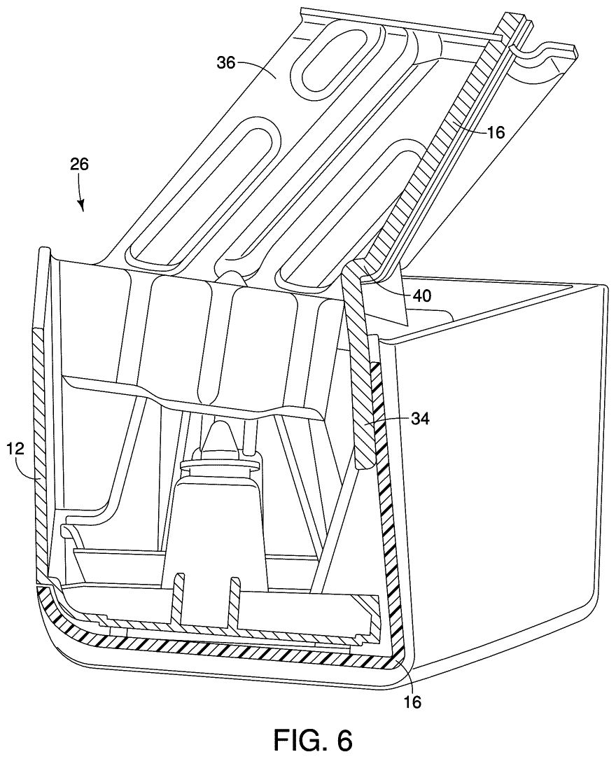

As seen in FIGS. 4 and 5, the trim molding 16 is provided with the fender baffle 14 such that the trim molding 16 can rotate in an inward direction L during installation to prevent the fender baffle 14 from protruding outward with respect to the baffle. In the illustrated embodiment, the term “inward” or “inner” will refer to a vehicle inward direction L that faces a vehicle interior as opposed towards the vehicle exterior of the vehicle that is equipped with the vehicle fender assembly 10. Preferably, the fender baffle 14 would be installed such that a seal 28 of the fender baffle 14 does not cover or interfere with a bead 32 of the fender 12 as will be further described below.

In particular, the fender baffle 14 has an alignment ramp 34 that engages the trim molding 16 such that the alignment ramp 34 guides the trim molding 16 to rotate inward or towards the vehicle body during installation. The trim molding 16 then is fastened to the fender 12 to lock the fender 12 and the fender baffle 14 in the proper position such that there is no resultant door interference with the components of the vehicle fender assembly 10.

As best seen in FIGS. 2 to 5, the alignment ramp 34 defines a bottom outer edge of the fender baffle 14 that faces the vehicle outward direction O when the fender baffle 14 is installed to the fender 12. The fender baffle 14 includes a main plate that is cantilevered with respect to the fender 12 and the sill 18. The fender baffle 14 has a seal 28 extending from the main plate that abuts against the sill 18.

The alignment ramp 34 has a longitudinal length protruding from the main plate in a vehicle downward direction D. In the illustrated embodiment, the term “downward” or “lower” will refer to a vehicle downward direction D towards a vehicle floor and away from a vehicle roof of the vehicle that is equipped with the vehicle fender assembly 10.

The alignment ramp 34 includes a stepped attachment structure 40 that contacts the trim molding 16 when the trim molding 16 is installed to the fender baffle 14. The fender 12 has the bead 32 that is attached to the sill 18 in a vehicle rearward direction R with respect to the main body 24 of the fender 12. In the illustrated embodiment, the term “rearward” or “rear” will refer to a vehicle rear direction towards a rear end of the vehicle that is equipped with the vehicle fender assembly 10.

The fender baffle 14 covers the bead 32 when the fender 12 is installed to the sill 18. As shown, the fender 12 has a fastening structure that attaches the fender 12 to the sill 18 in the vehicle rearward direction R with respect to the main body 24 of the fender 12. The fastening structure is illustrated as a grommet. The fender baffle 14 uncovers the fastening structure when the fender 12 is installed to the sill 18. That is, the installation of the trim molding 16 preferably pushes into an installed position that covers the bead 32 but does not cover the grommet.

As stated, the trim molding 16 is installed to the fender 12 and the fender baffle 14 along the alignment ramp 34. The alignment ramp 34 enables the trim molding 16 to rotate towards the fender 12 in the inward direction L during installation to enclose a gap G between the fender 12 and the fender baffle 14. The trim molding 16 has a corresponding stepped attachment structure 44 that contacts the stepped attachment structure 40 of the alignment ramp 34. The vehicle fender assembly 10 further comprises at least one fastening structure fixedly connecting the trim molding 16 to the fender 12. The trim molding 16 is fastened to the fender 12 by the fastening structures, such as screws or bolts.

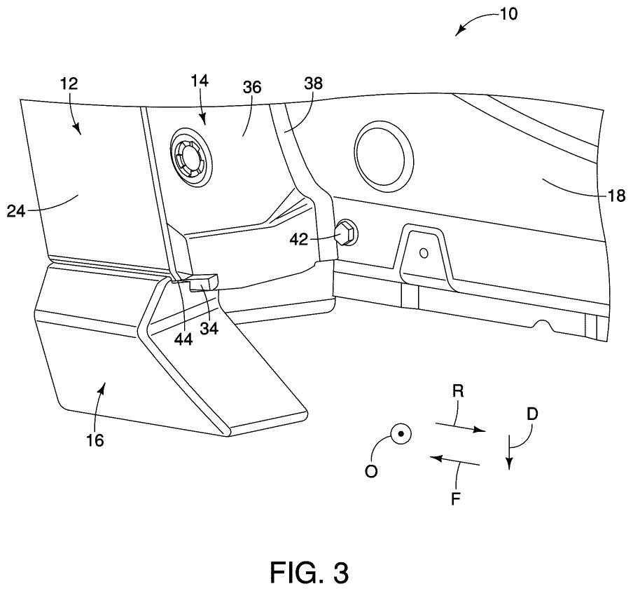

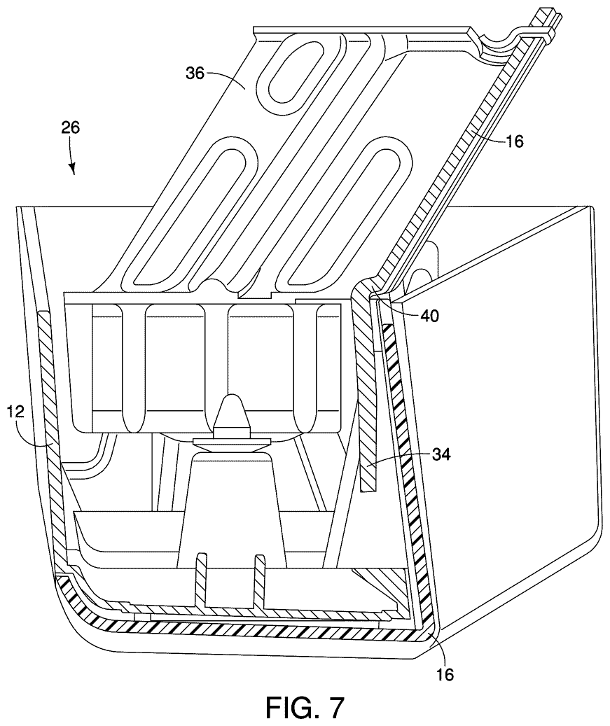

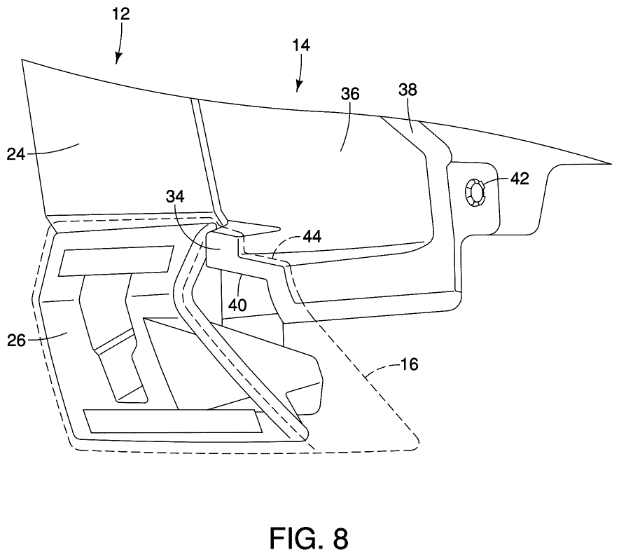

In the illustrated embodiment, a method for assembling the vehicle fender assembly 10 is disclosed. The method comprises installing the fender baffle 14 to the fender 12. The method further comprises installing the trim molding 16 to the fender 12 and the fender baffle 14 by sliding the trim molding 16 along the alignment ramp 34 to rotate the trim molding 16 towards the fender 12 during installation to enclose the gap G between the fender 12 and the fender baffle 14, as seen in FIGS. 4 to 7. As seen in FIG. 3, a pathway PI illustrates a rotation path of the trim molding 16 in an inward direction to avoid interfering with the grommet 42. A pathway P2 illustrates a rotation path of the trim molding 16 following the pathway P1 outward towards the installed orientation. The pathway P3 illustrates an installed outline of the trim molding 16 when fulling installed.

The method further comprises installing the fender 12 to the sill 18 with the fender baffle 14 disposed between the sill 18 and the fender 12. The method further comprises covering the bead 32 of the fender 12 when the fender 12 is installed to the sill 18, the bead 32 being attached to the sill 18 in the vehicle rearward direction R with respect to the main body 24 of the fender 12. The method further comprises fastening at least one fastening structure to the trim molding 16 to fixedly connect the trim molding 16 to the fender baffle 14, as seen in FIG. 3.

In understanding the scope of the present invention, the term “comprising” and its derivatives, as used herein, are intended to be open ended terms that specify the presence of the stated features, elements, components, or groups, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle fender assembly. Accordingly, these terms, as utilized to describe the present invention should be interpreted relative to a vehicle equipped with the vehicle fender assembly.

The term “configured” as used herein to describe a component, section or part of a device that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A vehicle fender assembly comprising:
a fender that is part of a vehicle body defining a tire installation area;
a fender baffle that is a sound reducer installed to the fender, the fender baffle having an alignment ramp defining a bottom outer edge of the fender baffle that faces a vehicle direction when the fender baffle is installed to the fender; and
a trim molding installed to the fender and the fender baffle along the alignment ramp, the alignment ramp enabling the trim molding to rotate towards the fender during installation to enclose a gap between the fender and the fender baffle.

2. The vehicle fender assembly according to claim 1, further comprising
a sill partially defining a vehicle door opening, the fender being installed to the sill with the fender baffle disposed between the fender and the sill.

3. The vehicle fender assembly according to claim 2, wherein
the fender baffle includes a main plate that is cantilevered with respect to the fender and the sill, the alignment ramp having a longitudinal length protruding from the main plate in a vehicle downward direction.

4. The vehicle fender assembly according to claim 3, wherein
the alignment ramp includes a stepped attachment structure that contacts the trim molding when the trim molding is installed to the fender baffle.

5. The vehicle fender assembly according to claim 4, wherein
one or the other of the fender and the sill has a bead located in a vehicle rearward direction with respect to a main body of the fender, the fender baffle covering the bead when the fender is installed to the sill.

6. The vehicle fender assembly according to claim 5, wherein
the trim molding has a corresponding stepped attachment structure that contacts the stepped attachment structure of the alignment ramp.

7. The vehicle fender assembly according to claim 6, wherein
the fender includes a main body and a lower attachment structure extending below the main body, the lower attachment structure being received by the trim molding to fixedly connect the fender to the fender baffle.

8. The vehicle fender assembly according to claim 7, further comprising
at least one fastening structure fixedly connecting the trim molding to the fender.

9. The vehicle fender assembly according to claim 4, wherein
the fender has a fastening structure that attaches the fender to the sill in a vehicle rearward direction with respect to a main body of the fender, the fender baffle uncovering the fastening structure when the fender is installed to the sill.

10. A method for assembling a vehicle fender assembly, the method comprising:
installing a fender baffle that is a sound reducer to a fender that is part of a vehicle body defining a tire installation area, the fender baffle having an alignment ramp defining a bottom outer edge of the fender baffle; and
installing a trim molding to the fender and the fender baffle by sliding the trim molding along the alignment ramp to rotate the trim molding towards the fender during installation to enclose a gap between the fender and the fender baffle.

11. The method according to claim 10, further comprising
installing the fender to the sill with the fender baffle disposed between the sill and the fender.

12. The method according to claim 11, wherein
one or the other of the fender and the sill has a bead located in a vehicle rearward direction with respect to a main body of the fender,
the method further comprising cover the bead when the fender is installed to the sill.

13. The method according to claim 12, further comprising
fastening at least one fastening structure to the trim molding to fixedly connect the trim molding to the fender baffle.

14. The method according to claim 11, wherein
the fender has a fastening structure attaches the fender to the sill in a vehicle rearward direction with respect to a main body of the fender,
the fender baffle uncovering the bead when the fender is installed to the sill.
